(19) United States
(12) Patent Application Publication
(10) Pub. No.: US 2026/0134862 A1
(43) Pub. Date: May 14, 2026

(54) SYSTEM AND APPARATUS FOR COMMUNICATING VIA ASL TO SPEECH

(71) Applicant: Father Flanagan's Boys' Home Doing Business as Boys Town National Research Hospital, Omaha, NE (US)

(72) Inventor: Maurice Bailey, Omaha, NE (US)

(21) Appl. No.: 19/388,051

(22) Filed: Nov. 13, 2025

Related U.S. Application Data
(60) Provisional application No. 63/719,945, filed on Nov. 13, 2024.

(51) Int. Cl. G10L 13/027; G06V 10/764; G06V 20/20; G06V 40/20; G10L 15/26

(52) U.S. Cl. CPC G10L 13/027; G06V 10/764; G06V 20/20; G06V 40/28; G10L 15/26

(57) ABSTRACT

Eyewear equipped with a LiDAR sensor and a wide-angle lens uses computer vision to process American Sign Language (ASL) and convert it to speech. This wearable device facilitates communication between the hearing impaired and individuals who do not understand ASL or may need help understanding at least some parts of ASL. It is seamlessly integrated with a phone or other smart device and can be managed through an app. The data is transmitted from the wearable device to the phone and then to a server for the ASL-to-speech and speech-to-text models. The device serves as a dynamic display, presenting augmented reality captions from the speaker via speech-to-text, producing clear audio for ASL-to-speech, and accurately recognizing ASL through the camera and Lidar.

### CROSS REFERENCE TO RELATED APPLICATIONS

This application claims priority under 35 U.S.C. § 119(e) to provisional patent application U.S. Ser. No. 63/719,945, filed Nov. 13, 2024. The provisional patent application is hereby incorporated by reference in its entirety herein, including without limitation: the specification, claims, and abstract, as well as any figures, tables, appendices, or drawings thereof.

### TECHNICAL FIELD

The present disclosure relates generally to a system and/or apparatus for language translation involving American Sign Language. More particularly, but not exclusively, the disclosure includes translation features for both parties in a conversation when at least one of the parties is using American Sign Language and the other is using verbal speaking.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

American Sign Language (ASL) is a natural language that serves as the predominant sign language of Deaf communities in the United States and most of Anglophone Canada. ASL is a complete and organized visual language that is expressed by employing both manual and nonmanual features. Reliable estimates for American ASL users range from 250,000 to 500,000 persons, including a number of children of deaf adults and other hearing individuals.

ASL signs have a number of phonemic components, such as movement of the face, the torso, and the hands. ASL is not a form of pantomime although iconicity plays a larger role in ASL than in spoken languages. English loan words are often borrowed through fingerspelling, although ASL grammar is unrelated to that of English. ASL has verbal agreement and aspectual marking and has a productive system of forming agglutinative classifiers.

Because of the nature of ASL, the learning can take time. In addition, if one person knows ASL and is trying to communicate with one or more people who do not know ASL, there can be a language barrier, making it difficult to communicate.

There have been attempts to address this, such as by creating gloves that attempt to audibly announce the words, terms, or other descriptors the wearer is attempting to communicate via ASL. For example, the wearer may be a deaf person or person who is otherwise not able to communicate effectively in an audible manner. When this is accurate, it can be useful for the non-verbal wearer to be able to attempt to communicate with others who may not readily understand ASL based on the actions alone. However, in the cases where the wearer is hard of hearing, if the other party(s) does not know how to reciprocate using ASL, the conversation may still be one sided and there may still be the communication issues.

Thus, there exists a need in the art for a system and/or apparatus that allows for two-way communication between individuals, especially when at least one of the individuals uses ASL and the other may not understand.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of at least some of the embodiments of the present disclosure to offer a seamless communication solution for deaf or hard-of-hearing individuals and those who may not be familiar with American Sign Language (ASL).

It is still yet a further object, feature, and/or advantage of at least some of the present disclosure to facilitates communication between the hearing impaired and individuals who do not understand ASL. For example, a system can be integrated with a phone, tablet, or other smart device and managed with an app. Data is transmitted from the device to the phone and then to a server for the ASL-to-speech and speech-to-text models. The device serves as a dynamic display, presenting augmented reality captions from the speaker via speech-to-text, producing clear audio for ASL-to-speech, and accurately recognizing ASL through the camera and Lidar.

It is still another object, feature, and/or advantage of at least some of the embodiments to include a wearable device, such as glasses, which can project text from a speaking person or device.

The apparatus and/or system disclosed herein can be used in a wide variety of applications. For example, while it is envisioned that the system is used between people, it should be appreciated that components, such as a wearable component, could be used by a deaf or hard-of-hearing individual to translate to text any audio communication.

It is preferred the apparatus be safe, cost effective, and durable. [For example, . . . ] [the apparatus can be adapted to resist excessive heat, static buildup, corrosion, and/or mechanical failures (e.g., cracking, crumbling, shearing, creeping) due to excessive impacts and/or prolonged exposure to tensile and/or compressive forces acting on the apparatus.]

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the system.

According to some aspects of the present disclosure, a system for facilitating communication between ASL and non-ASL users comprises a vision system to detect one or more movements of a first user; a processor in communication with the vision system, the processor comprising a model trained to identify one or more classifiers that associate the one or more movements of the user with a letter, word, and/or phrase of American Sign Language (ASL); an output generator in communication with the processor to audibly output the letter, word, and/or phrase of ASL; a receiver in communication with the processor to receive an audible speech, wherein the processor converts the audible speech into visual text; and a display configured to show the visual text received from the processor.

According to at least some aspects and/or embodiments, the system further comprises a wearable device, wherein the vision system, output generator, receiver, and display are part of the wearable device.

According to at least some aspects and/or embodiments, the wearable device comprises glasses.

According to at least some aspects and/or embodiments, the vision system comprises a camera and/or LiDAR.

According to at least some aspects and/or embodiments, the output generator comprises a speaker.

According to at least some aspects and/or embodiments, the receiver comprises a microphone.

According to at least some aspects and/or embodiments, the processor is located independently of the vision system, output generator, receiver, and display.

According to at least some aspects and/or embodiments, the processor is a smart device.

According to at least some aspects and/or embodiments, the model is a machine-learned model.

According to at least some aspects and/or embodiments, the display comprises a mixed reality display, and the visual text comprises live captioning.

According to additional aspects of the present disclosure, a method of communication comprises identifying, via a vision system, one or more letters, words, and/or phrases associated with ASL based upon one or more movements of a first individual; converting, the identified one or more letters, words, and/or phrases associated with ASL into synthetic speech using a machine-learned model that has been trained to identify classifiers associating the one or more movements with the one or more one or more letters, words, and/or phrases associated with ASL; receiving, via a microphone, audible language from a second individual; and displaying, via a mixed reality user interface, a text-based version of the audible language for the first individual.

According to at least some aspects and/or embodiments, the machine-learned model is located on a processor that is independent of the vision system.

According to at least some aspects and/or embodiments, the synthetic speech is broadcasted via a speaker.

According to at least some aspects and/or embodiments, the vision system, microphone, and mixed reality user interface are part of a wearable device.

According to at least some aspects and/or embodiments, the wearable device comprises glasses.

According to still additional aspects of the present disclosure, a system for facilitating communication involving the use of ASL comprises a wearable device comprising a vision system, a speaker, a microphone, and a wireless communication module; a machine-learned model that has been trained to identify classifiers associating one or more movements of an individual with one or more one or more letters, words, and/or phrases associated with ASL; and a processor in communication with the wearable device and the machine-learned model, the processor including instructions comprising: identifying one or more letters, words, and/or phrases associated with ASL based upon the one or more movements of the individual; converting the identified one or more letters, words, and/or phrases associated with ASL into synthetic speech; receiving audible language; and displaying a text-based version of the audible language for the individual.

According to at least some aspects and/or embodiments, the wearable device comprises glasses, and displaying the text-based version of the audible language comprises displaying in a mixed reality interface via the glasses.

According to at least some aspects and/or embodiments, the vision system, speaker, and microphone of the wearable device in communication with the processor via one or more wireless communication protocols.

According to at least some aspects and/or embodiments, the vision system comprises a camera and/or LiDAR.

According to at least some aspects and/or embodiments, the processor is located on a smart device, and the machine-learned model either on the smart device or in wireless communication with the smart device.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a schematic of a system for facilitating communication between a user of ASL and a non-user of ASL.

FIG. 2 is a flow diagram of a process for converting and translating ASL movements into audible synthetic text.

FIG. 3 is a flow diagram of a process for converting audible dialogue into a readable text via a display.

FIG. 4 is an example model and communication setup for a system that facilitates communication between a user of ASL and a non-user of ASL.

FIG. 5 is an example of a vision system identifying and communicating movements related to ASL to a model for conversion and translation into an audio file.

FIG. 6 is an example of an audio system broadcasting the translated ASL movements via a component of the audio system.

FIG. 7 is an example of ASL movements that have been converted and broadcast as an audio file.

FIG. 8 is an example of a mixed reality display from a wearer of glasses of a communication system showing audible speech that has been converted to text and shown in the mixed reality via the system of the present disclosure.

FIG. 9 is a schematic figure showing components of embodiments of a communication system as is shown and described in the present disclosure, including aspects of various components of the system.

FIG. 10 is an embodiment of a wearable device that can be used with the communication system of the present disclosure, showing various aspects of the wearable device.

FIG. 11 is a depiction of a user wearing the wearable device shown in FIG. 10.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

American Sign Language (hereinafter, ASL) has opened many avenues in terms of the ability for hearing impaired people to be able to more uniformly communicate. While the term ASL is used herein to refer generally to the complete and organized visual language that is expressed by employing both manual and nonmanual features, it is recognized that there are variations, including varieties, both within the US and around the world. For purposes of the present disclosure, the use of the term “ASL” will be used to connote all variations of sign language that is used for communication by and between both those that are hearing impaired and those that may be attempting to communicate with someone who is hearing impaired.

However, there are still many instances when there may be a communication attempted by a person or people who know ASL and one or more people who either do not know ASL at all, or who may have a limited understanding of the language. For example, it is noted that ASL involves different movements that connote a letter, word, phrase, or combination thereof. Combinations of movements are strung together to form sentences and thus are used as part of normal conversations. Thus, while there have been attempts at electronically understanding and/or translating ASL to people who may not fully understand the language, there thus far has been a lapse in the reverse side of the communication where the non-ASL user is trying to further the facilitation of dialogue with the ASL user.

Therefore, as will be understood, aspects and/or embodiments of the present disclosure relate to systems and/or methods that enable a two-way communication and conversation between at least one person who may know ASL and one or more individuals who either do not know ASL at all, or who may not be fluent enough to have a conversation.

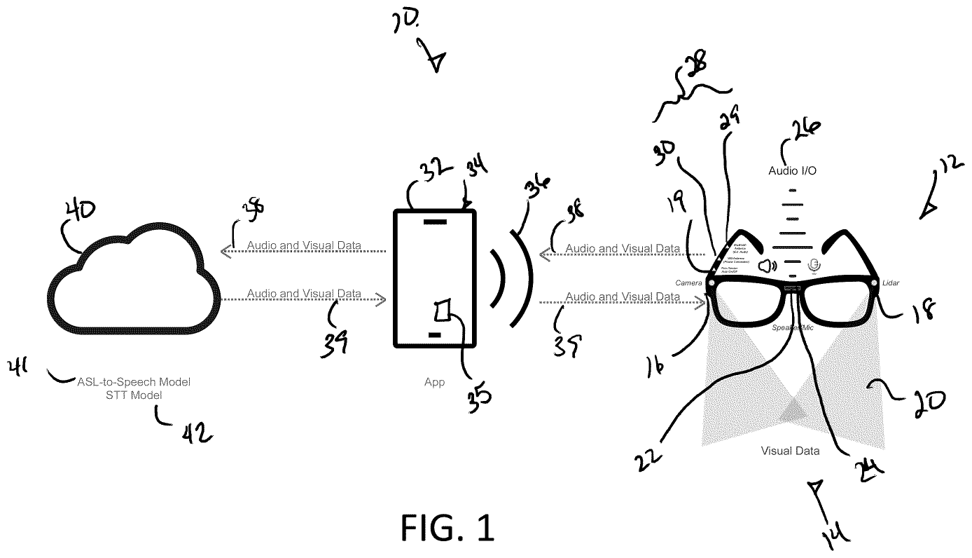

Referring to FIG. 1, a communication system 10 for facilitating communication and/or a conversation between at least two people is shown. As noted, the people involved will include at least one person who is using ASL for the majority of their communication (e.g., a hearing impaired individual) and a person who may be able to hear and may not have a good enough grasp to understand ASL. Addressing both parties will provide numerous advantages and improvements over that which has previously been disclosed.

The system 10 includes a wearable device 12, shown to be glasses, which is worn by the ASL user. While glasses are shown, it should be appreciated that these are not the only type of device considered or envisioned. Generally, any device, wearable or otherwise, which can be placed in close proximity to the ASL to be able to view the movements associated with ASL and to have a wireless module and other features as will be included can be considered a part of the disclosure. This includes, but is not limited to, gloves, watches, standalone devices, mounted devices, laptops, phones, handhelds, tablets, and other smart devices. However, for example purposes, the disclosure will be considered with the view that glasses is the device visually identifying the ASL movements.

The glasses 12 will include a vision system 14. The vision system 14 is used to view and track the one or more movements of the user when conversing using ASL. For example, as shown in FIG. 1, there are one or more areas where visual data 20 can be viewed and tracked via the vision system 14. According to at least some embodiments, the vision system 14 comprises a camera 16, such as a wide-angle lens style camera (although other types of cameras, including stereo cameras, are to be considered), and/or a range determining sensor, such as a Lidar sensor 18. Lidar, also LIDAR, LiDAR or LADAR, an acronym of “light detection and ranging” or “laser imaging, detection, and ranging”, is a method for determining ranges by targeting an object or a surface with a laser and measuring the time for the reflected light to return to the receiver. Lidar may operate in a fixed direction (e.g., vertical) or it may scan multiple directions, in which case it is known as lidar scanning or 3D laser scanning, a special combination of 3-D scanning and laser scanning.

The vision system 14 is used to track the movement of the wearer communicating via ASL, so it is best to have a broad angle to be able to see the placement and movement of the user, as will be understood. In addition to the Lidar 18 and camera 16, the wearable device may also include one or more other sensors 19. This can include, but is not limited to, proximity sensors, motion detectors, other type of cameras, and the like. The additional sensors can be used to aid in determining the movement associated with ASL by the user.

The wearable device 12 will include audio inputs/outputs 26 (e.g., a speaker 22 and/or microphone 24) that will be used with the system 10 to facilitate the communication between two people, wherein one user uses and/or understands ASL and the other does not. For example, the user of the wearable device 12 may be hearing impaired and need to rely upon ASL (at least in part) to be able to best communicate. Another person in the conversation may not readily understand ASL. As will be understood, captured movements will be able to be broadcast as synthetic text via a speaker 22, which is part of the device 12. In addition, the device 12 can include a microphone 24 to pick up audible speech from the non-ASL user, which will then be translated and reformatted into readable text for the ASL user, such as by way of augmented or mixed realities through the wearable device 12.

In some embodiments, the device 12 could include one or more communications ports such as Ethernet, serial advanced technology attachment (“SATA”), universal serial bus (“USB”), or integrated drive electronics (“IDE”), for transferring, receiving, or storing data.

The speaker 22 can be any speaker that is capable of receiving and broadcasting an audio file. In general, a speaker is a combination of one or more speaker drivers, an enclosure, and electrical connections (possibly including a crossover network). The speaker driver is an electroacoustic transducer that converts an electrical audio signal into a corresponding sound.

Likewise, the microphone 24 can be any device that is able to pick up on sounds and transmit them to a model for conversion into text. A microphone, colloquially called a mic or mike, is a transducer that converts sound into an electrical signal. As will be understood, the microphone will be able to pick up spoken dialogue that can be translated and shown as text to the wearer of the device 12, which allows the user to understand spoken dialogue, even if they may be hearing impaired.

Additional input/output may be included, such as a user display. The user display can be the lenses of the glasses, or can be part of augmented or mixed reality that is shown/seen via the glasses 12. As will be understood, text and other information can be shown via the display to the user/wearer of the device 12 to aid in facilitating communication.

Still further, the wearable device 12 can include data transmission and/or communication modules 28, which can include wireless communication protocols. The device 12 may include a Bluetooth module 29, WiFi module 30, cellular antenna, near field communications, and/or any other type of wireless data transmission and/or communications, which will allow data to be transmitted to and from the device 14.

Additional components of the system 10 include a processor 32 in communication with the device 12. The processor 32 is a component that can control the flow of data and provide additional instructions for the operation of the components of the system 10. The processor 32 can be any intelligent control and can be found on generally any device. For example, FIG. 1 indicates a processor 32 as part of a handheld device 34, which may be a smart device. A smart device is an electronic device, generally connected to other devices or networks via different wireless protocols (such as Bluetooth, Zigbee, near-field communication, Wi-Fi, NearLink, Li-Fi, or 5G) that can operate to some extent interactively and autonomously. Several notable types of smart devices are smartphones, smart speakers, smart cars, smart thermostats, smart doorbells, smart locks, smart refrigerators, phablets and tablets, smartwatches, smart bands, smart keychains, smart glasses, and many others. The term can also refer to a device that exhibits some properties of ubiquitous computing, including—although not necessarily—machine learning.

For example, the smart device 34 may be a smartphone that includes a downloadable app 35 that can include a connection to a server or other processor (not shown) that includes instructions on computer readable medium and/or memory, which controls the functions and operations of the components of the system. Thus, the processor can be a part of the phone, or remote, such as at a remote location or even in the cloud. The smart device 34 will include wireless communication protocols and modules as well to be able to wireless communicate and transmit data with the wearable device 12. This is shown by the arrows 38, 39 in FIG. 1, which shows the two-way transmission of data between the components.

Still further, the system 10 can include models, such as an ASL-to-Speech Model 41 and a Speech to Text (STT) Model 42. These models can be housed on a remote server or even in the cloud. The models 41, 42 are in wireless communication with the smart device 34 to add functionality to the system. For example, as will be understood, the models can receive information from the processor/smart device that has been passed from the vision system 14 of the wearable device 12. The models will be used to essentially translate and/or convert information from one form to another. For example, the ASL-to-Speech Model 41 can receive movement information from the vision system 14 of the wearable device and, based upon training of the model, can identify classifiers in the form of letters, words, and/or phrases associated with the provided movement. The model 41 will process the information and send the identified letters, words, and/or phrases back to the wearable device 12 via the processor 32 in the form of a synthetic speech file. This file can then be broadcast via the speaker 22 of the wearable device to audibly broadcast the synthetic speech file. Thus, a non-ASL user will be able to understand what the ASL user is trying to communicate via ASL movements captured by the vision system 14.

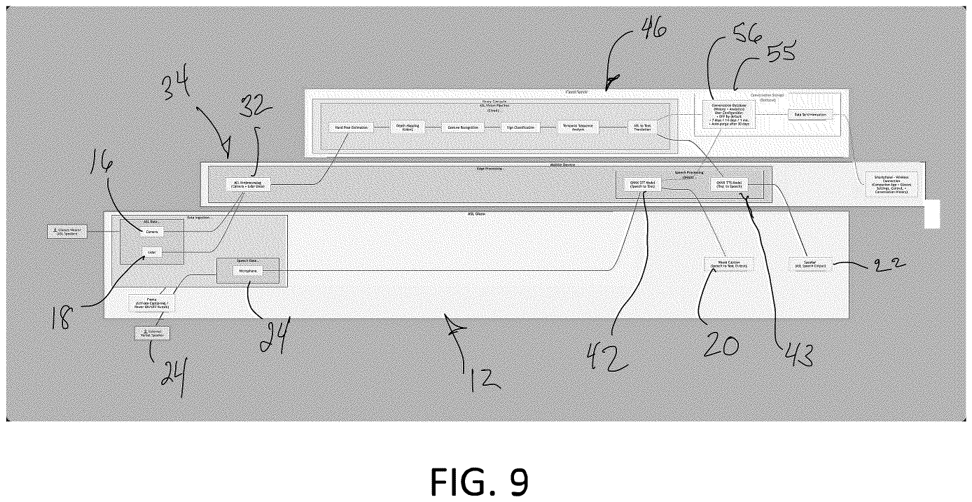

FIG. 9 is a schematic showing components and/or architecture, including more details for the communication system 10 and the connectivity between various components thereof, including some optional aspects for the system. As noted, the system 10 can include cloud computing, which may also be referred to as cloud processing, which includes cloud services 46 (this is also referred to as a “compute layer”, which includes processors and/or modules in the cloud environment for aiding in the operation of the system 10). The cloud computing 46 can include various components of the system 10 that will be in communication with the wearable device 12 (e.g., wearable smart glasses) and the smart device 34 (e.g., smartphone). The cloud computing services will allow greater processing than is included in either of the smart device 34 and/or the wearable device 12 and can also be utilized to perform more operations. Still further, the cloud system 46 can be connected to multiple wearable devices and/or smart devices to be able to handle, concurrently, the processing needed for multiple people to be communicating using aspects of the system, whether they are in the same conversation or not. This includes people in different geographical areas as well all in communication with the cloud processing 46 to perform the communications, while the cloud processing handles various aspects of the system.

For example, as shown in FIG. 9, the cloud processing system 46 can include a heavy computing module, which can include processers. This can house aspects of the ASL Vision Pipeline. For example, heavy computing/processing module can be trained to process and translate a user's ASL movements into text via the pipeline. As one aspect, the module includes a first step including determination/estimation of a hand pose. As shown by the connecting lines in the figure, the process starts with the wearable device 12, which includes the camera 16 and/or LIDAR sensor 18. The movement is detected by the camera 16 and/or LIDAR sensor 18 and communicated to the processor 40 (ASL Preprocessing) of the smart device 34. Next, in the cloud module, depth mapping via the LIDAR, gesture recognition, sign classification, and temporal sequence analysis is computed in the cloud model to provide the ASL to Text Translation. This translation is then communicated to the speech processing at the smart device 34 to convert speech to text 42 and text to speech 43. The text to speech is communicated to a speaker 22 of the wearable device 34, which may be on the frame or other structural component of the device. The speaker 22 emits the speech to text to the non-ASL user to convey the determined ASL movements of the ASL communicator. Thus, the ASL speech can be converted into verbal speech via the system to allow the ASL speaker to communicate a message to the non-ASL user.

In reverse, the schematic shows how the non-ASL user is able to communicate to the ASL speaker using the system. As shown, the non-ASL speaker (shown as “External Verbal Speaker” in FIG. 9) speaks and the audio is picked up by a microphone 24, which may be on the frame or other portion of the wearable device 12. The audio file is transmitted from the microphone 24 to a speech to text model 42, which is able to take the audio file and convert to a text file. The text can be communicated to the ASL speaker via the wearable device, such as by way of visual caption 20 on a display portion of the wearable device 12. This can be part of a virtual or augmented reality, or can just be a simple text output for the ASL speaker to read.

Therefore, the figure shows components and connectivity thereof for a communication system 10 in which an ASL speaker and a non-ASL speaker are able to communicate using components of the system 10.

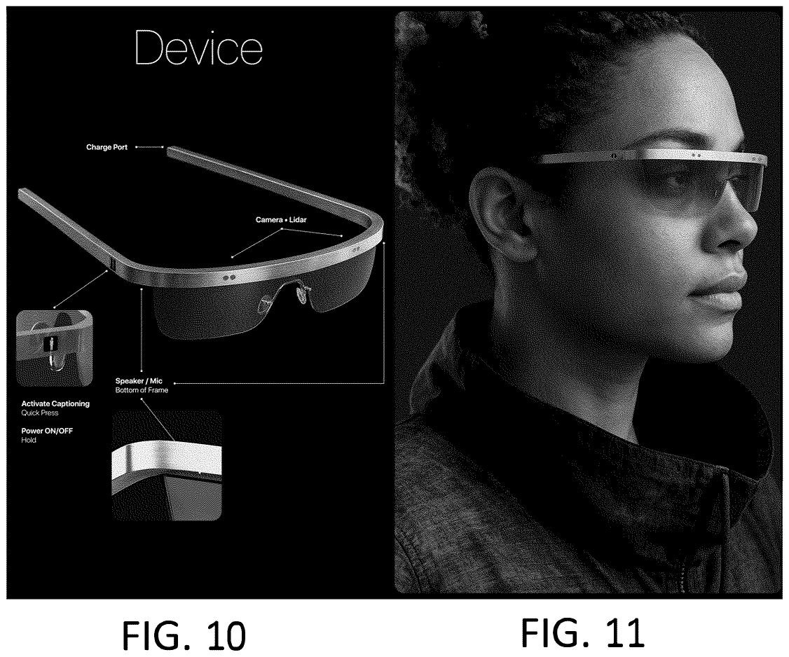

FIG. 10 shows additional components of the system 10, which may be optional in that they are not required for all embodiments. For example, the figure shows an optional Conversation Storage module 55, which may constitute memory. The Conversation Storage module can include a Conversation Database 56, which allows conversations with the system 10 to be saved for some amount of time. The module can also save analytics of any conversation.

As shown in the figure, the Conversation Database 56 can be “user configurable” in that the user is able to set up. This includes turning off/on for any or all of conversations that are utilized with the system 10. In addition, a user can configure an amount of time that any conversation is saved. The figure shows some examples, such as 7-days, 14-days, 1-month, etc. In addition, the database can be set to auto-purge (i.e., delete conversations) after some amount of time, which can be selected by the user of the system 10. The Conversation Storage Module can also include a Data Synchronization module that is connected to the Conversation Database 56 to set up how the data is organized and saved.

As shown, the optional Conversation Storage module 55 can be part of the cloud computing system 46. However, it could also be a local memory/storage system that is connected to the components of the system to allow for optional storage.

The ASL-to-Speech Model 41 can be a machine-learned model or neural network that has been trained to identify and classify movements and associate such movements with a letter, word, and/or phrase associated with ASL.

As noted, aspects and/or embodiments disclosed herein will utilize processors, memory, instructions, and the like, and will include a machine learning model or models to identify classifiers of aspects of ear conditions and/or pathologies. Machine learning (ML) is the study of computer algorithms that can improve automatically through experience and by the use of data. It is seen as a part of artificial intelligence. Machine learning algorithms build a model based on sample data, known as “training data”, in order to make predictions or decisions without being explicitly programmed to do so.

While it is envisioned that generally any type of ML (e.g., supervised learning, unsupervised learning, semi-supervised learning, or reinforcement learning) can be utilized by any of the aspects and/or embodiments of the present disclosure utilize supervised learning. Supervised learning (SL) is the machine learning task of learning a function that maps an input to an output based on example input-output pairs. It infers a function from labeled training data consisting of a set of training examples. In supervised learning, each example is a pair consisting of an input object (typically a vector) and a desired output value (also called the supervisory signal). A supervised learning algorithm analyzes the training data and produces an inferred function, which can be used for mapping new examples. An optimal scenario will allow the algorithm to correctly determine the class labels for unseen instances. This requires the learning algorithm to generalize from the training data to unseen situations in a “reasonable” way (see inductive bias). This statistical quality of an algorithm is measured through the so-called generalization error.

To solve a given problem of supervised learning, one has to perform the following steps: (1) Determine the type of training examples. Before doing anything else, the user should decide what kind of data is to be used as a training set. (2) Gather a training set. The training set needs to be representative of the real-world use of the function. Thus, a set of input objects is gathered, and corresponding outputs are also gathered, either from human experts or from measurements. (3) Determine the input feature representation of the learned function. The accuracy of the learned function depends strongly on how the input object is represented. Typically, the input object is transformed into a feature vector, which contains a number of features that are descriptive of the object. The number of features should not be too large, because of the curse of dimensionality; but should contain enough information to accurately predict the output. (4) Determine the structure of the learned function and corresponding learning algorithm. For example, the engineer may choose to use support-vector machines, regression analysis, or decision trees. (5) Complete the design. Run the learning algorithm on the gathered training set. Some supervised learning algorithms require the user to determine certain control parameters. These parameters may be adjusted by optimizing performance on a subset (called a validation set) of the training set, or via cross-validation. (6) Evaluate the accuracy of the learned function. After parameter adjustment and learning, the performance of the resulting function should be measured on a test set that is separate from the training set.

As will be understood, while generally any type of SL can be utilized, the example provided herein utilized three different classification algorithms to train the model, namely the support vector machine (SVM), k-Nearest Neighbors (k-NN), and classification ensemble (ENS).

Support-vector machines (SVMs, also support-vector networks) are supervised learning models with associated learning algorithms that analyze data for classification and regression analysis. Given a set of training examples, each marked as belonging to one of two categories, an SVM training algorithm builds a model that assigns new examples to one category or the other, making it a non-probabilistic binary linear classifier (although methods such as Platt scaling exist to use SVM in a probabilistic classification setting). SVM maps training examples to points in space so as to maximize the width of the gap between the two categories. New examples are then mapped into that same space and predicted to belong to a category based on which side of the gap they fall.

The k-nearest neighbors algorithm (k-NN) is a non-parametric classification method. k-NN is a type of classification where the function is only approximated locally, and all computation is deferred until function evaluation. Since this algorithm relies on distance for classification, if the features represent different physical units or come in vastly different scales then normalizing the training data can improve its accuracy dramatically.

Classification ensemble may also be referred to as ensemble learning. Ensemble methods use multiple learning algorithms to obtain better predictive performance than could be obtained from any of the constituent learning algorithms alone. Unlike a statistical ensemble in statistical mechanics, which is usually infinite, a machine learning ensemble consists of only a concrete finite set of alternative models, but typically allows for much more flexible structure to exist among those alternatives.

The trained model and the associated machine learning and application of the model will utilize processors, modules, memories, databases, networks, and potentially user interfaces to show the results and allow changes to be made.

Additionally, as noted, the system 10 includes the use of a STT model 42. Speech recognition is an interdisciplinary subfield of computer science and computational linguistics that develops methodologies and technologies that enable the recognition and translation of spoken language into text by computers. It is also known as automatic speech recognition (ASR), computer speech recognition or speech-to-text (STT). It incorporates knowledge and research in the computer science, linguistics, and computer engineering fields. The reverse process is speech synthesis. Any number or type of STT model 42 that is able to recognize and identify spoken dialogue and convert to text is considered a part of the present disclosure, and the disclosure is not to be limited to any specific type of STT model 42.

Referring back to FIG. 1, the arrows 38 and 39 indicate the flow or transmission of data between the components of the system 10. As will be understood, an example can include data communicated from the glasses 12 via the arrow 38 to the smart device/processor 32/34 and to the model 41/42. The return arrow 39 shows the wireless transmission of data from the models 41, 42 to the device 12, which will facilitate communications between two users.

Referring now to the additional figures, and in particular, FIGS. 1-6, a process of using the system to aid in the facilitation of communication between two users will be provided. For example purposes, the process will be considered to include two users, a first user 48 who may be hearing impaired and who is able to use and understand ASL, and a second user 49, who may be able to hear and who is not as proficient (or even totally lacking) with respect to an understanding of ASL.

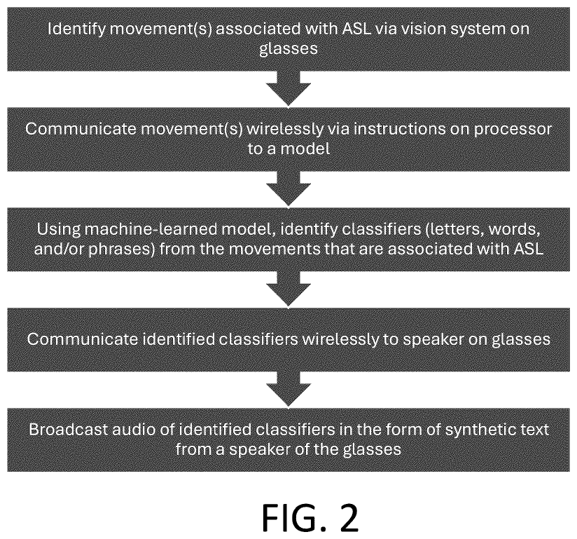

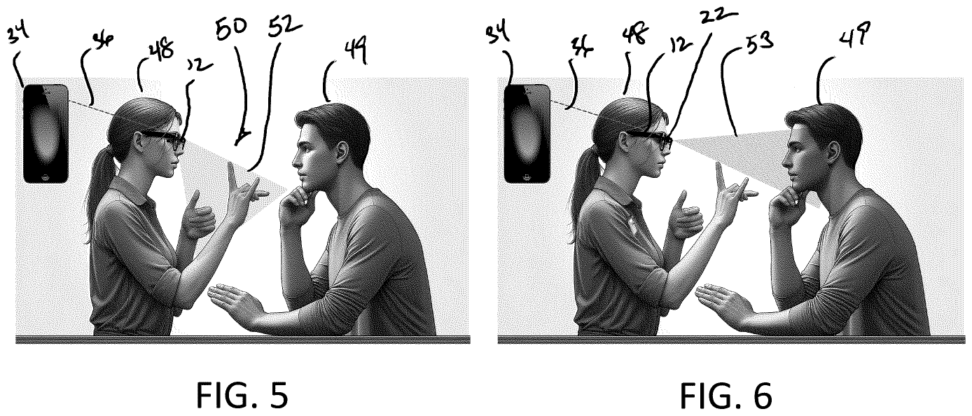

The first user 48 wears the wearable device 12, which is shown in the form of glasses. As best shown in FIG. 5, the first user 48 begins communicating via ASL movements. The vision system 14, which includes the Lidar 18, camera 16, and/or sensor(s) 19, picks up the ASL movements of the first user 48. This is shown as the first step of the flow diagram in FIG. 2, which includes identification of movement(s) associated with ASL via the vision system 14 on the device 12. The wireless communication modules 28 (e.g., Bluetooth 29, WiFi 30, or other) then communicates the movement(s) wirelessly via instructions on a processor 32 (such as via an app 35 on a smart device 34) to an ASL-to-Speech Model 41, which includes a machine-learned model. This is shown as the second step in FIG. 2. The model identifies classifiers (letters, words, and/or phrases) from the movements that are associated with ASL (step 3).

At step 4 of FIG. 2, the identified classifiers are combined in a way that can be communicated wirelessly to the wearable device 12, such as in an audio file. This audio file will be configured such that the resulting audio will be in the form of spoken dialogue (i.e., the ASL movements will be ordered in a way that is understandable in spoken form). Finally, the audio file is broadcast via the speaker 22 in the wearable device 12 in the form of synthetic text to the second user 49. The audio broadcast area 53 is shown in FIG. 6, wherein the figure shows that the audio file is being directed at the second user so that they are able to receive and hear the synthetic text from the speaker.

Thus, FIGS. 2 and 5-6 show an example of how aspects of the present disclosure will allow a non-ASL user to be able to understand the ASL movements of an ASL user to be able to further a conversation.

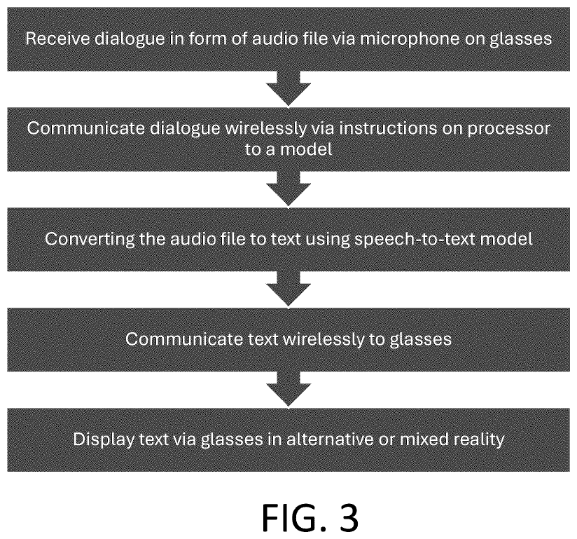

Moving to FIG. 3, the process of allowing the ASL user 48 to understand communications from the non-ASL user 49 will be described. The non-ASL user 49 communicates via audible spoken dialogue towards the wearable device 12. The microphone 24 of the device 12 can pick up the spoken dialogue in the form of an audio file (step 1 in FIG. 3). This audio file can then be communicated wirelessly via the processor (such as on the smart device) towards the STT model 42. The STT model 42 may be on the smart device or stored separately on a remote server or even in a cloud environment. Using the STT model 42, the audio file is converted to a text file. This text file is then wirelessly communicated back towards the glasses 12 via the processor/smart device. The glasses 12 then display the text of the text file on a display, which may be the lens themselves, or through the lens in a mixed and/or augmented reality.

Augmented reality (AR) is an interactive experience that combines the real world and computer-generated 3D content. The content can span multiple sensory modalities, including visual, auditory, haptic, somatosensory, and olfactory. AR can be defined as a system that incorporates three basic features: a combination of real and virtual worlds, real-time interaction, and accurate 3D registration of virtual and real objects. The overlaid sensory information can be constructive (i.e., additive to the natural environment), or destructive (i.e., masking of the natural environment). As such, it is one of the key technologies in the reality-virtuality continuum.

This experience is seamlessly interwoven with the physical world such that it is perceived as an immersive aspect of the real environment. In this way, augmented reality alters one's ongoing perception of a real-world environment, whereas virtual reality completely replaces the user's real-world environment with a simulated one.

Augmented reality is largely synonymous with mixed reality. There is also overlap in terminology with extended reality and computer-mediated reality.

The primary value of augmented reality is the manner in which components of the digital world blend into a person's perception of the real world, not as a simple display of data, but through the integration of immersive sensations, which are perceived as natural parts of an environment.

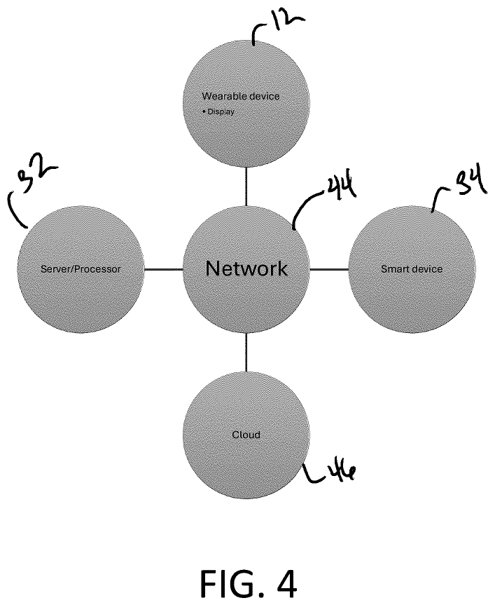

FIG. 4 shows an example of the wireless setup, wherein the network 44 connects all of the components of the system 10. As noted, the network 44 can include any sort or type of wireless communication protocol. The wearable device 12, smart device 34, server/processor 32, and a cloud environment 46 can all be connected via the network 44 to allow the components to communicate with one another in real time, which will allow the facilitation of the communication between users of the system 10.

In some embodiments, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein. The network typically allows communication between the communications module and the central location during moments of low-quality connections. Communications through the network can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

The Internet Protocol (“IP”) is the principal communications protocol in the Internet protocol suite for relaying datagrams across network boundaries. Its routing function enables internetworking, and essentially establishes the Internet. IP has the task of delivering packets from the source host to the destination host solely based on the IP addresses in the packet headers. For this purpose, IP defines packet structures that encapsulate the data to be delivered. It also defines addressing methods that are used to label the datagram with source and destination information.

The Transmission Control Protocol (“TCP”) is one of the main protocols of the Internet protocol suite. It originated in the initial network implementation in which it complemented the IP. Therefore, the entire suite is commonly referred to as TCP/IP. TCP provides reliable, ordered, and error-checked delivery of a stream of octets (bytes) between applications running on hosts communicating via an IP network. Major internet applications such as the World Wide Web, email, remote administration, and file transfer rely on TCP, which is part of the Transport Layer of the TCP/IP suite.

Transport Layer Security, and its predecessor Secure Sockets Layer (“SSL/TLS”), often runs on top of TCP. SSL/TLS are cryptographic protocols designed to provide communications security over a computer network. Several versions of the protocols find widespread use in applications such as web browsing, email, instant messaging, and voice over IP (VoIP”). Websites can use TLS to secure all communications between their servers and web browsers.

As noted herein, the system 10 includes numerous electrical and/or computer modules, equipment, protocols, and the like. The following is a description of at least some components, protocols, and/or systems, which may be used with the system 10. However, note that not all are used or required.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

The system will include an intelligent control (i.e., a controller) and components for establishing communications. Examples of such a controller may be processing units alone or other subcomponents of computing devices. The controller can also include other components and can be implemented partially or entirely on a semiconductor (e.g., a field-programmable gate array (“FPGA”)) chip, such as a chip developed through a register transfer level (“RTL”) design process.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The memory includes, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

In the instant case, the memory could include the machine learned classifiers, so as to fit the parameters of the model and to quickly and accurately identify the results based on the trained classifiers.

Generally, the non-transitory computer readable medium operates under control of an operating system stored in the memory. The non-transitory computer readable medium implements a compiler which allows a software application written in a programming language such as COBOL, C++, FORTRAN, or any other known programming language to be translated into code readable by the central processing unit. After completion, the central processing unit accesses and manipulates data stored in the memory of the non-transitory computer readable medium using the relationships and logic dictated by the software application and generated using the compiler.

In one embodiment, the software application and the compiler are tangibly embodied in the computer-readable medium. When the instructions are read and executed by the non-transitory computer readable medium, the non-transitory computer readable medium performs the steps necessary to implement and/or use the present invention. A software application, operating instructions, and/or firmware (semi-permanent software programmed into read-only memory) may also be tangibly embodied in the memory and/or data communication devices, thereby making the software application a product or article of manufacture according to the present invention.

The database is a structured set of data typically held in a computer. The database, as well as data and information contained therein, need not reside in a single physical or electronic location. For example, the database may reside, at least in part, on a local storage device, in an external hard drive, on a database server connected to a network, on a cloud-based storage system, in a distributed ledger (such as those commonly used with blockchain technology), or the like.

It is envisioned that the machine learned models and any of the training of the same could include cloud computing. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

A cloud computing environment is service oriented with a focus on statelessness, low coupling, modularity, and semantic interoperability. At the heart of cloud computing is an infrastructure comprising a network of interconnected nodes.

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

The use of a cloud or cloud computing has been included. There are different types of cloud computing models considered.

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

The power supply outputs a particular voltage to a device or component or components of a device. The power supply could be a direct current (“DC”) power supply (e.g., a battery), an alternating current (“AC”) power supply, a linear regulator, etc. The power supply can be configured with a microcontroller to receive power from other grid-independent power sources, such as a generator or solar panel.

With respect to batteries, a dry cell battery may be used. Additionally, the battery may be rechargeable, such as a lead-acid battery, a low self-discharge nickel metal hydride battery (“LSD-NiMH”) battery, a nickel-cadmium battery (“NiCd”), a lithium-ion battery, or a lithium-ion polymer (“LiPo”) battery. Careful attention should be taken if using a lithium-ion battery or a LiPo battery to avoid the risk of unexpected ignition from the heat generated by the battery. While such incidents are rare, they can be minimized via appropriate design, installation, procedures, and layers of safeguards such that the risk is acceptable.

The power supply could also be driven by a power generating system, such as a dynamo using a commutator or through electromagnetic induction. Electromagnetic induction eliminates the need for batteries or dynamo systems but requires a magnet to be placed on a moving component of the system.

The power supply may also include an emergency stop feature, also known as a “kill switch,” to shut off the machinery in an emergency or any other safety mechanisms known to prevent injury to users of the machine. The emergency stop feature or other safety mechanisms may need user input or may use automatic sensors to detect and determine when to take a specific course of action for safety purposes.

A user interface is how the user interacts with a machine. The user interface can be a digital interface, a command-line interface, a graphical user interface (“GUI”), oral interface, virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the UI can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

The sensors sense one or more characteristics of an object and can include, for example, accelerometers, position sensors, pressure sensors (including weight sensors), or fluid level sensors among many others. The accelerometers can sense acceleration of an object in a variety of directions (e.g., an x-direction, a y-direction, etc.). The position sensors can sense the position of one or more components of an object. For example, the position sensors can sense the position of an object relative to another fixed object such as a wall. Pressure sensors can sense the pressure of a gas or a liquid or even the weight of an object. The fluid level sensors can sense a measurement of fluid contained in a container or the depth of a fluid in its natural form such as water in a river or a lake. Fewer or more sensors can be provided as desired. For example, a rotational sensor can be used to detect speed(s) of object(s), a photodetector can be used to detect light or other electromagnetic radiation, a distance sensor can be used to detect the distance an object has traveled, a timer can be used for detecting a length of time an object has been used and/or the length of time any component has been used, and a temperature sensor can be used to detect the temperature of an object or fluid.

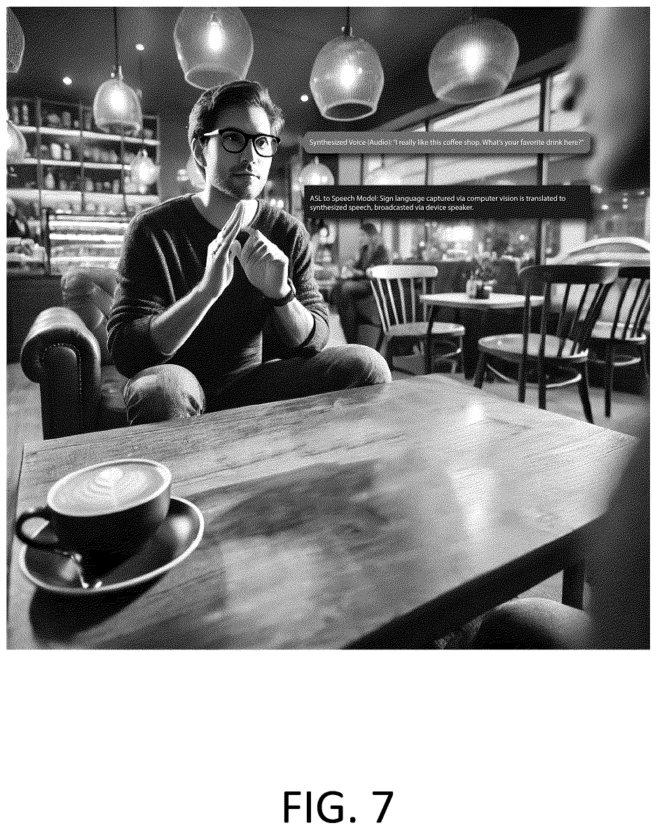

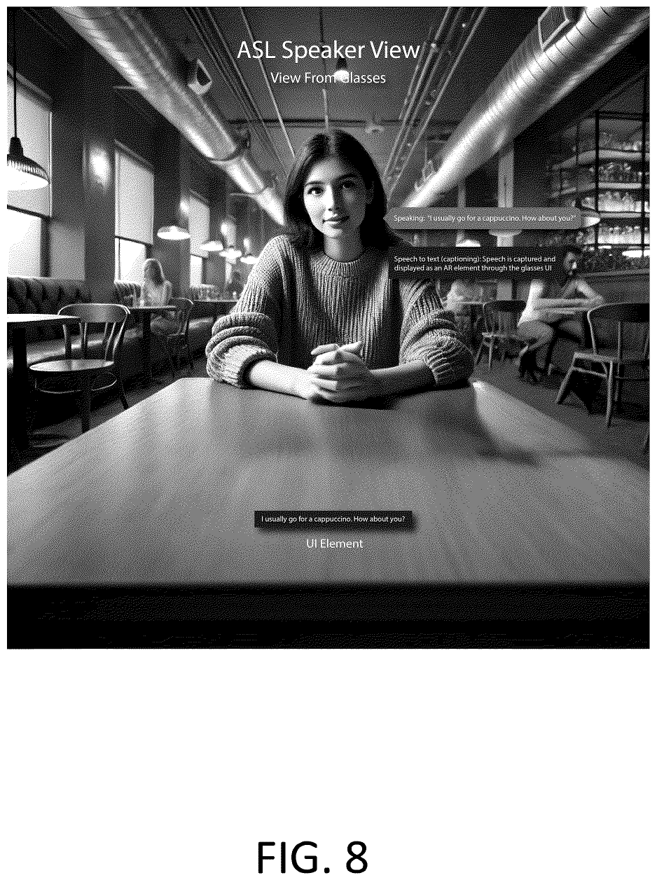

FIGS. 7 and 8 show additional examples of using the system 10 of the present disclosure to facilitate a conversation between a first user who may know ASL and also may be hearing impaired, and a second user who is not proficient in ASL and may be able to hear. FIG. 7 shows the first user wearing glasses such as those described herein. The location of the conversation is shown to be a public space, such as a coffee shop. The first user has utilized ASL movements to convey a message via the ASL-to-Speech Model, in which sign language is captured via computer vision and translated to synthesized speech that is broadcast via a speaker on or associated with the glasses. In the example of FIG. 7, the first user has signed and the speaker broadcasts (in near real time), “I really like this coffee shop. What's your favorite drink here?” This was the result of sign language that is broadcast as synthetic text towards the second user.

FIG. 8 shows an example of view through the glasses worn by the first user. The second user is shown across a table. As shown, the second user audibly speaks, “I usually go for a cappuccino. How about you?” Note that this is in response to the query from the first user. As noted, this audio file is transmitted to a STT model where speech is captured and displayed as an AR element through the glass's user interface. The user interface element is shown near the bottom of the figure, where the text, “I usually go for a cappuccino. How about you?” is shown in the augmented reality.

Thus, the users are able to have a conversation in real time and with the limitations each may have had if not for the system of the present disclosure. Therefore, as will be understood, the system and/or methods disclosed provide numerous advantages and improvements. The ASL-to-Speech and Live Captioning Mixed Reality (MR) Glasses offer a seamless communication solution for deaf or hard-of-hearing individuals and those who may not be familiar with American Sign Language (ASL).

The ASL-to-Speech and Live Captioning Mixed Reality (MR) Glasses employ advanced computer vision and an ASL model to recognize and interpret sign language accurately. The ASL is then converted into synthetic speech, allowing the observer to understand ASL. Simultaneously, spoken dialogue from the observer is transformed into text and displayed within the Mixed Reality Glasses, using Speech-To-Text (STT), providing real-time captions for individuals with hearing impairments.

FIGS. 10 and 11 show additional aspects of the disclosure. FIG. 10 shows an example of a wearable device 12 in the form of wearable glasses, which can be used by the ASL-user to allow communication with a non-ASL speaker. It should be noted that the glasses shown are but one example, and any or all of the figure is not to be limiting on the disclosure, as the wearable device could take many different forms while still including the functionality and ability to allow an ASL speaker to communicate with a non-ASL speaker, and vice versa.

The wearable device 12 shown in FIGS. 10-11 comprises smart glasses designed for assistive communication, particularly between an ASL speaker (ASL-to-Speech Translation) and a Non-ASL Speaker communicating verbally (Speech-to-Text Captioning). Hardware components include, but are not limited to:
Frame with Activate Button: A tactile button on the right temporal frame.
Camera+Lidar Modules: Circular sensors positioned above each eye for gesture and depth capture.
Microphone Array: Hidden under the frame for voice input.
Speaker: Hidden under the frame for discreet audio output (spoken word).
Connectivity: Wireless for communication with a paired smart device (e.g., a smartphone).
Relay Device (Phone or other Smart Device): Runs the companion app (cloud), manages connectivity, and interfaces with the distributed compute layer.
Distributed Compute Layer (Cloud and/or Edge): Handles heavy ML interface, analytics, and model updates.

### User Interactions & Functions of the System Include

Power ON/OFF: Hold the activate button for a few seconds to power the device on or off.
Begin Translation: Quick press the activate button once to start ASL capture and translation mode. Glasses begin streaming sensor data (video, depth, audio) to the relay device.
End Translation: Quick press again to stop translation mode. System halts data capture and returns to standby.
Conversation Storage (UX): Toggle—“Store conversations locally” (Off by default). Retention Slider—7 days→14 days→1 month. Auto-purge: Default ON after 30-days. Storage Meter—Shows current usage.

The operation flow of the system, which has been described herein, can be summarized as follows:
1. User powers on device→glasses (or other wearable device) connect to phone (or other smart device).
2. Quick press to start translation→cameras and LiDAR capture gestures; mic captures audio context.
3. Data sent to phone→relayed to distributed compute layer for ASL recognition and text-to-speech (TTS) synthesis.
4. Spoken output delivered through the speaker.
5. Quick press to end translation→system stops streaming and processing.

Therefore, systems and methods to facilitate communication involving ASL have been shown and/or described. It should be appreciated that variations and/or changes to any of the components or embodiments that are obvious to those skilled in the art are to be considered a part of the present disclosure. In addition, any of the aspects of any of the embodiments disclosed could be combined in ways not explicitly shown and/or described to provide yet additional embodiments that are part of the disclosure. The disclosure is not to be limited to the embodiments disclosed herein.

1. A system for facilitating communication between ASL and non-ASL users, comprising:
a vision system to detect one or more movements of a first user;
a processor in communication with the vision system, the processor comprising a model trained to identify one or more classifiers that associate the one or more movements of the user with a letter, word, and/or phrase of American Sign Language (ASL);
an output generator in communication with the processor to audibly output the letter, word, and/or phrase of ASL;
a receiver in communication with the processor to receive an audible speech, wherein the processor converts the audible speech into visual text; and
a display configured to show the visual text received from the processor.

2. The system of claim 1, further comprising a wearable device, and wherein the vision system, output generator, receiver, and display are part of the wearable device.

3. The system of claim 2, wherein the wearable device comprises glasses.

4. The system of claim 1, wherein the vision system comprises a camera and/or LiDAR.

5. The system of claim 1, wherein the output generator comprises a speaker.

6. The system of claim 1, wherein the receiver comprises a microphone.

7. The system of claim 1, wherein the processor is located independently of the vision system, output generator, receiver, and display.

8. The system of claim 1, wherein the processor is a smart device.

9. The system of claim 1, wherein the model is a machine-learned model.

10. The system of claim 1, wherein the display comprises a mixed reality display, and the visual text comprises live captioning.

11. A method of communication, comprising:
identifying, via a vision system, one or more letters, words, and/or phrases associated with ASL based upon one or more movements of a first individual;
converting, the identified one or more letters, words, and/or phrases associated with ASL into synthetic speech using a machine-learned model that has been trained to identify classifiers associating the one or more movements with the one or more one or more letters, words, and/or phrases associated with ASL;
receiving, via a microphone, audible language from a second individual; and
displaying, via a mixed reality user interface, a text-based version of the audible language for the first individual.

12. The method of claim 11, wherein the machine-learned model is located on a processor that is independent of the vision system.

13. The method of claim 11, wherein the synthetic speech is broadcasted via a speaker.

14. The method of claim 11, wherein the vision system, microphone, and mixed reality user interface are part of a wearable device.

15. The method of claim 14, wherein the wearable device comprises glasses.

16. A system for facilitating communication involving the use of ASL, the system comprising:
a wearable device comprising a vision system, a speaker, a microphone, and a wireless communication module;
a machine-learned model that has been trained to identify classifiers associating one or more movements of an individual with one or more one or more letters, words, and/or phrases associated with ASL; and
a processor in communication with the wearable device and the machine-learned model, the processor including instructions comprising:
identifying one or more letters, words, and/or phrases associated with ASL based upon the one or more movements of the individual;
converting the identified one or more letters, words, and/or phrases associated with ASL into synthetic speech;
receiving audible language; and
displaying a text-based version of the audible language for the individual.

17. The system of claim 16, wherein the wearable device comprises glasses, and displaying the text-based version of the audible language comprises displaying in a mixed reality interface via the glasses.

18. The system of claim 16, wherein the vision system, speaker, and microphone of the wearable device in communication with the processor via one or more wireless communication protocols.

19. The system of claim 16, wherein the vision system comprises a camera and/or LiDAR.

20. The system of claim 16, wherein the processor is located on a smart device, and the machine-learned model either on the smart device or in wireless communication with the smart device.
